(19) United States
(12) Patent Application Publication
(10) Pub. No.: US 2026/0211506 A1
(43) Pub. Date: Jul. 23, 2026

(54) SMART GLASSES DEVICE, OBJECT ACTIVATION FUNCTION EXECUTING METHOD, AND NON-TRANSITORY COMPUTER READABLE STORAGE MEDIUM THEREOF

(71) Applicant: HTC Corporation, Taoyuan City (TW)

(72) Inventors: Chang Hua WEI, Taoyuan City (TW); Sheng-Cherng LIN, Taoyuan City (TW)

(21) Appl. No.: 19/032,106

(22) Filed: Jan. 19, 2025

(51) Int. Cl. G06F 3/01; G06V 20/20

(52) U.S. Cl. CPC G06F 3/017; G06F 3/013; G06V 20/20

(57) ABSTRACT

A smart glasses device, object activation function executing method, and non-transitory computer readable storage medium thereof are provided. The device stores an image identity list, and the image identity list includes objects and an object activation function corresponding to each of the objects. The device captures a real-time image. The device determines whether a target object appears in the real-time image, and the target object is one of the objects. In response to the target object appearing in the real-time image, the device executes the object activation function corresponding to the target object based on a user input corresponding to a user and the image identity list.

### BACKGROUND

### Field of Invention

The present invention relates to a smart glasses device, an object activation function executing method, and non-transitory computer readable storage medium thereof. More particularly, the present invention relates to a smart glasses device, an object activation function executing method, and non-transitory computer readable storage medium thereof that can instantly execute an object activation function corresponding to a target object.

### Description of Related Art

In the existing technology, objects in the environment (e.g., electronic devices) still rely on direct contact by users to perform corresponding control operations. However, there may be multiple objects in the environment corresponding to different functions. When the object is located in a place that cannot be directly touched by the user, the user needs to move to the location of the object before performing control operations on the object, which causes inconvenience in use.

In addition, in the existing technology, numerical information about objects in the environment still relies on manual recording by the user (e.g., the water volume of the water bottle, the value of the weighing scale), and there is a lack of a mechanism to automatically perform numerical recording.

Accordingly, there is an urgent need for an object activation function executing technology that can instantly execute the function of the corresponding object.

### SUMMARY

An objective of the present disclosure is to provide a smart glasses device. The smart glasses device comprises a storage, an image capturing device, and a processor. The processor is electrically connected to the storage and the image capturing device. The storage is configured to store an image identity list, and the image identity list comprises a plurality of objects and an object activation function corresponding to each of the objects. The image capturing device is configured to capture a real-time image. The processor determines whether a target object appears in the real-time image, and the target object is one of these objects. In response to the target object appearing in the real-time image, the processor executes the object activation function corresponding to the target object based on a user input corresponding to a user and the image identity list.

Another objective of the present disclosure is to provide an object activation function executing method, which is adapted for use in a smart glasses device. The smart glasses device comprises a storage, an image capturing device, and a processor, the storage is configured to store an image identity list, and the image identity list comprises a plurality of objects and an object activation function corresponding to each of the objects. The image capturing device is configured to capture a real-time image. The object activation function executing method comprises the following steps: determining whether a target object appears in the real-time image, wherein the target object is one of these objects; and in response to the target object appearing in the real-time image, executing the object activation function corresponding to the target object based on a user input corresponding to a user and the image identity list.

A further objective of the present disclosure is to provide a non-transitory computer readable storage medium having a computer program stored therein. The computer program comprises a plurality of codes, the computer program executes an object activation function executing method after being loaded into an electronic system. The electronic system comprises a storage, an image capturing device, and a processor. The storage is configured to store an image identity list, the image identity list comprises a plurality of objects and an object activation function corresponding to each of the objects, and the image capturing device is configured to capture a real-time image. The object activation function executing method comprises the following steps: determining whether a target object appears in the real-time image, wherein the target object is one of these objects; and in response to the target object appearing in the real-time image, executing the object activation function corresponding to the target object based on a user input corresponding to a user and the image identity list.

According to the above descriptions, the object activation function executing technology (at least including the device, the method, and the non-transitory computer readable storage medium) provided by the present disclosure can actively identify the target object in the environment, and determine the object activation function to be executed for the target object based on the stored image identity list. In addition, the object activation function executing technology provided by the disclosure also provides a variety of operating mechanisms to further provide a variety of remote control methods and different object activation functions, solving the shortcomings of the existing technology and improving user experience services.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic diagram depicting the applicable scenario of the smart glasses device of the first embodiment;

FIG. 2A is a schematic diagram depicting the structure of the smart glasses device of some embodiments;

FIG. 2B is a schematic diagram depicting the structure of the smart glasses device of some embodiments;

FIG. 3 is a schematic diagram depicting the smart glasses device of some embodiments;

FIG. 4A is a schematic diagram depicting the target real-time image of some embodiments;

FIG. 4B is a schematic diagram depicting the display screen of some embodiments;

FIG. 5 is a schematic diagram depicting the display screen of some embodiments;

FIG. 6 is a schematic diagram depicting the remote control of some embodiments;

FIG. 7 is a schematic diagram depicting the gesture of some embodiments;

FIG. 8 is a schematic diagram depicting the remote control of some embodiments;

FIG. 9 is a schematic diagram depicting the remote control of some embodiments; and

FIG. 10 is a partial flowchart depicting the object activation function executing method of the second embodiment.

### DETAILED DESCRIPTION

In the following description, a smart glasses device, an object activation function executing method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

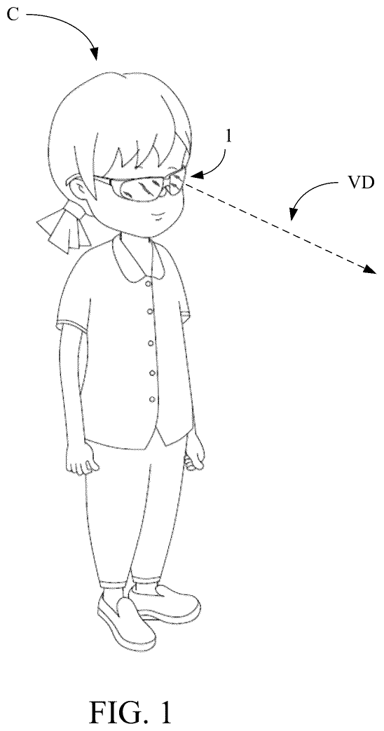

First, the applicable scenario of the present embodiment will be described, and a schematic diagram of which is depicted in FIG. 1. As shown in FIG. 1, in the application environment of the present disclosure, the user C can use the smart glasses device 1 to perform daily activities, and the smart glasses device 1 actively identifies objects in the environment to perform the object activation function of the corresponding object.

For example, when the user C is standing in the physical space, the user C can control the mobile phone placed on the table in front through the smart glasses device 1 to perform related functional operations of the mobile phone, such as: clicking the virtual button on the screen of the mobile phone, answer the call, hang up the call.

For another example, when the user C wears the smart glasses device 1 and scans the environment, the smart glasses device 1 can automatically record the values on the objects in the environment (for example: the water volume scale of the water bottle, the value of the weighing scale).

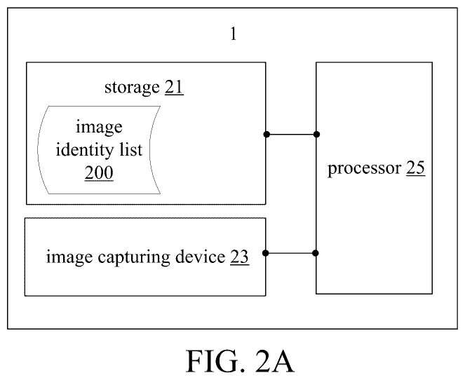

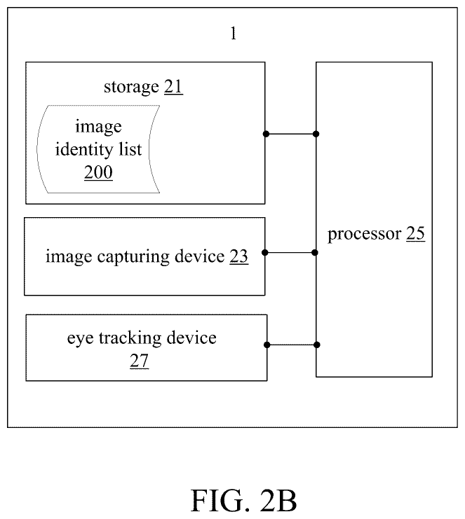

In the present embodiment, a schematic diagram of the structure of the smart glasses device 1 is depicted in FIG. 2A. The smart glasses device 1 comprises a storage 21, an image capturing device 23, and a processor 25. The processor 25 is electrically connected to the storage 21 and the image capturing device 23.

In the present embodiment, the storage 21 is configured to store an image identity (ID) list 200. The image identity list 200 comprises a plurality of objects and an object activation function corresponding to each of the objects.

It shall be appreciated that the smart glasses device 1 can establish the image identity of each corresponding object by capturing images from multiple angles of the object (for example, two-dimensional images or three-dimensional images), and store them in the image identity list 200. The image identities of these objects can provide the subsequent comparison operations for object identification.

In some embodiments, each object may include one or multiple object activation functions. For example, the mobile phone can have the activation function of answering/hanging up calls and the activation function of playing media content.

In the present embodiment, the image capturing device 23 of the smart glasses device 1 is configured to capture a real-time image (for example, a real-time image of the front line of sight of the smart glasses device 1). In some embodiments, in order to make the computer vision identification of the environment or actions of the user C more accurate, the image capturing device 23 can capture continuous images (e.g., streaming images). The continuous images are used to perform subsequent real-time image analysis operations.

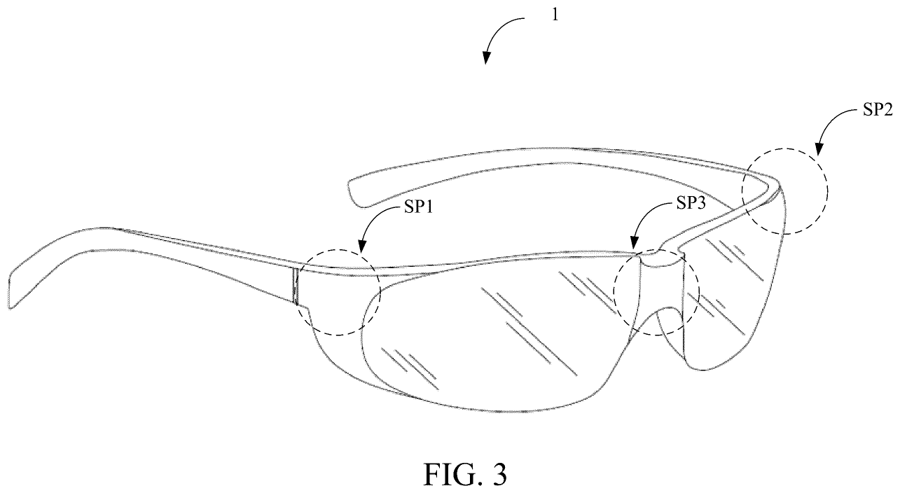

In some embodiments, a schematic diagram of the smart glasses device 1 is depicted in FIG. 3. As shown in FIG. 3, the image capturing device 23 can be disposed at the setting position SP1, SP2 or SP3 in FIG. 3.

For example, as the viewing direction VD of the user C shown in FIG. 1, the image capturing device 23 can be set based on the viewing direction VD of the user C (i.e., facing the same direction as the user's viewing direction VD).

In some embodiments, as shown in FIG. 2B, the smart glasses device 1 further comprises an eye tracking device 27. The eye tracking device 27 is used to generate the eyeball trajectory of the user C. For example, the eyeball trajectory of the user C can be generated by analyzing the positions of the user C's eyes (e.g., eye tracking technology).

It shall be appreciated that the storage 21 may be a memory, a Universal Serial Bus (USB) disk, a hard disk, a Compact Disk (CD), a mobile disk, or any other storage medium or circuit known to those of ordinary skill in the art and having the same functionality. The image capturing device 23 may be any device with the function of generating images (e.g., a camera, depth camera). The processor 25 may be any of various processors, Central Processing Units (CPUs), microprocessors, digital signal processors or other computing apparatuses known to those of ordinary skill in the art.

The following will specifically describe the details of the smart glasses device 1 in the present disclosure performing the object activation function of the corresponding object.

In the present embodiment, the smart glasses device 1 can first identify whether identifiable objects pre-stored in the image identity list 200 appear in the environment. Specifically, the processor 25 determines whether a target object appears in the real-time image, wherein the target object is one of these objects.

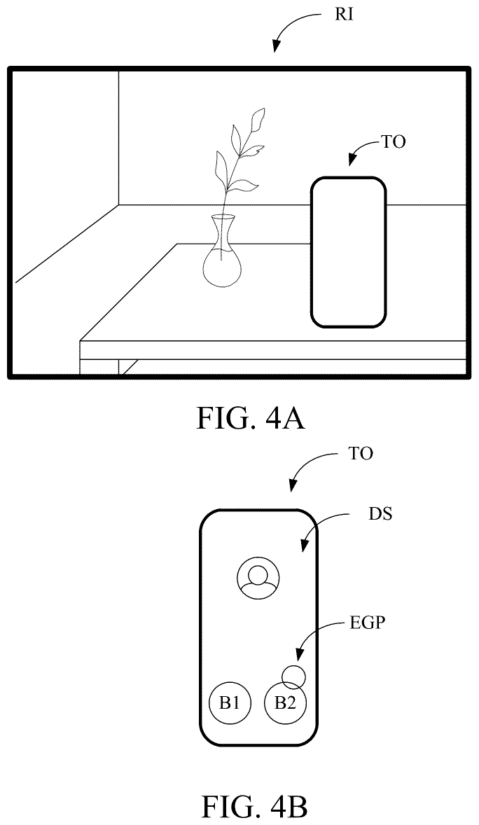

For example, as shown in FIG. 4A, the processor 25 may first analyze the objects to be identified that appear in the real-time image RI. Then, the processor 25 compares the object to be identified with the image identities of the objects in the image identity list 200 to determine whether an object matching the image identity appears in the real-time image (i.e., the target object TO).

In some embodiments, in order to reduce the computational burden of operation, the user C can actively activate the identification function of the smart glasses device 1 through various activation mechanisms, such as voice and preset activation gestures. The smart glasses device 1 can perform the identification operation of the target object TO after receiving the activation signal.

Next, in the present embodiment, in response to the target object TO appearing in the real-time image, the processor 25 executes the object activation function corresponding to the target object TO based on a user input corresponding to the user C and the image identity list 200.

It shall be appreciated that the user input may include any input controlled by the user C, such as eye gaze position, gestures, user viewing direction, etc. For example, the processor 25 can determine the user input of the user C by analyzing the data received by the smart glasses device 1 (such as real-time images or eyeball trajectories).

In some embodiments, the processor 25 can select one object activation function from at least one object activation function corresponding to the target object TO based on the image identity list 200. For example, the processor 25 can activate different object activation functions based on analyzing different gestures of the user C.

In some embodiments, in response to the target object TO disappearing in the real-time image (e.g., leaving a field of view (FOV) of the image capturing device 23), the processor 25 suspends execution of the object activation function corresponding to the target object TO.

In some embodiments, the suspend operation in the present disclosure includes the processor 25 temporarily stopping the execution of the object activation function (i.e., the object activation function corresponding to the target object TO will not be triggered or executed in this state).

In some embodiments, the suspend operation in the present disclosure includes that when the function corresponding to the target object TO has been activated, the processor 25 will forcibly terminate the operation of the activated function.

In some embodiments, when the target object TO is picked up, the operation of the object activation function can be suspended. Specifically, the processor 25 receives a plurality of inertial sensing data from the target object TO. Then, the processor 25 determines whether the target object TO is in a moving state based on the inertial sensing data. Finally, in response to the target object TO being in the moving state, the processor 25 suspends execution of the object activation function corresponding to the target object TO.

It shall be appreciated that in the present disclosure, the inertial sensing data may include one of accelerometer data, gyroscope data, ecompass data, or a combination thereof.

For ease of understanding, the operation embodiments of different object activation functions will be described in detail below.

In some embodiments, the object activation function corresponding to the target object TO comprises a screen display function. Specifically, in response to the target object TO appearing in the real-time image, the processor 25 determines whether the user input points to the target object TO (for example, the user C's gesture or eye gaze position points to the target object TO). Then, in response to the user input pointing to the target object TO, the processor 25 generates a first control signal corresponding to the target object TO to transmit the first control signal to the target object TO, wherein the first control signal is configured to wake up the screen display function of the target object TO.

For example, the processor 25 may transmit the control signal via a communication connection with the target object TO (e.g., via a Bluetooth connection with the target object TO).

In addition, in response to the user input stopping pointing to the target object TO, the processor 25 generates a second control signal corresponding to the target object TO to transmit the second control signal to the target object TO, wherein the second control signal is configured to suspend the screen display function of the target object TO.

For example, the processor 25 may continuously monitor the user's eye gaze position. When the processor 25 determines that the user's eye gaze position moves from the target object TO to another position in the environment (i.e., the user input stops pointing to the target object TO), the processor 25 may generate a control signal to notify the target object TO to turn off the screen to save power.

It shall be appreciated that the smart glasses device 1 can save the resource consumption of the target object TO through the aforementioned wake-up and suspend operations without letting the target object TO enter the sleep mode. Therefore, the operation performed by the target object TO itself can still be maintained (e.g., execute the application that is already running), and when the target object TO is awakened, the target object TO can continue to perform previous operations immediately.

In some embodiments, the object activation function corresponding to the target object TO comprises a remote control function, and the smart glasses device 1 can calculate whether the sight of the user C is located on the target object TO through the eyeball trajectory generated by the eye tracking device 27.

Specifically, in response to the target object TO appearing in the real-time image, the processor 25 determines whether an eye gaze position of the user C is on the target object TO based on the eyeball trajectory of the user C. Then, in response to the eye gaze position of the user C being on the target object TO, the processor 25 generates a third control signal corresponding to the target object TO based on the eye gaze position. Finally, the processor 25 transmits the third control signal to the target object TO to execute the remote control function corresponding to the target object TO.

For example, as shown in FIG. 4B, the display screen DS of the target object TO includes a virtual button B1 and a virtual button B2. In the present example, the processor 25 determines that the eye gaze position EGP of the user C is located at the virtual button B2 on the display screen DS of the target object TO. Then, the processor 25 generates a control signal for touching the virtual button B2 to the target object TO.

In some embodiments, the target object TO can also be preset with an operation interface corresponding to the remote control mode (for example, the virtual buttons are located in the peripheral area of the target object TO). For example, when the eye gaze position of the user C is located at the target object TO, the smart glasses device 1 can transmit a control signal to the target object TO, so that the target object TO enables the operation interface of the remote control mode in advance.

In some embodiments, since the target object TO may not face the smart glasses device 1 completely frontally, the smart glasses device 1 can calculate the ratio of the X-axis and Y-axis of the position of the user input corresponding to the target object TO to locate the true location of the user input (for example: eye gaze position).

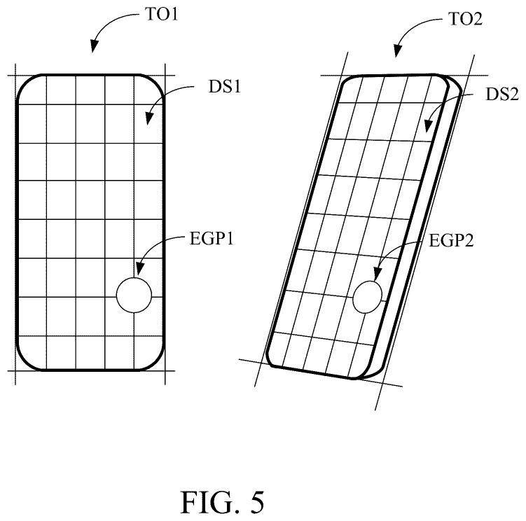

For example, as shown in FIG. 5, the processor 25 can calibrate the true position of the eye gaze position EGP1 by calculating the ratio of the X axis and the Y axis of the display screen DS1 of the target object TO1 corresponding to the eye gaze position EGP1. In addition, the processor 25 can calibrate the true position of the eye gaze position EGP2 by calculating the ratio of the X axis and the Y axis of the display screen DS2 of the target object TO2 corresponding to the eye gaze position EGP2.

In some embodiments, the object activation function corresponding to the target object TO comprises a remote control function, and the smart glasses device 1 can calculate the perspective of the user C through the gesture of the user and real-time images to determine whether the sight of the user C is on the target object TO. Specifically, in response to the target object TO appearing in the real-time image, the processor 25 determines a gesture of the user C based on the real-time image. Then, the processor 25 calculates a user viewing direction corresponding to the gesture based on the real-time image and the gesture.

Next, the processor 25 determines whether the user viewing direction is on the target object TO. In response to the user viewing direction being on the target object TO, the processor 25 generates a fourth control signal corresponding to the target object TO based on a focus point generated by the intersection of the user viewing direction and the target object TO. Finally, the processor 25 transmits the fourth control signal to the target object TO to execute the remote control function corresponding to the target object TO.

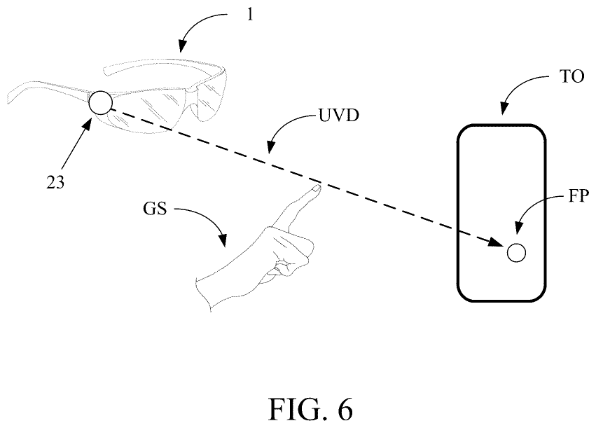

For example, as shown in FIG. 6, the processor 25 calculates the direction of the line connecting the image capturing device 23 and the gesture GS based on the real-time image captured by the image capturing device 23 to generate a user viewing direction UVD. Then, the processor 25 generates a control signal corresponding to the target object TO (for example: position return signal, virtual button selection signal) based on the focus point FP generated by the intersection of the user viewing direction UVD and the target object TO.

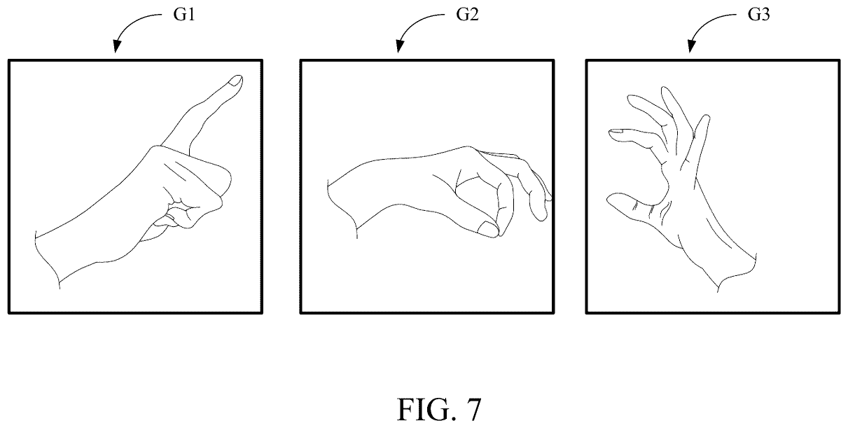

It shall be appreciated that in the present disclosure, the smart glasses device 1 can predefine control operations corresponding to different gestures. For example, as shown in FIG. 7, the gestures may be a gesture G1 with the index finger extended, a gesture G2 with the index finger and thumb spread out for pinching, and a gesture G3 with the palm opened for grabbing. In the present example, the gesture G1 corresponds to the control operation of clicking, the gesture G2 corresponds to the control operation of transfer (i.e., moving the content to another location), and the gesture G3 corresponds to the control operation of zooming in/out.

In some embodiments, the objects in the image identity list 200 can be divided into electronic devices or non-electronic devices. The electronic device can establish a communication connection (such as Bluetooth) with the smart glasses device 1 to perform corresponding control operations. Specific implementations of the electronic device will be described below.

In some embodiments, the processor 25 can determine whether the object is located at a distance capable of image identity identification (i.e., in-sight zone) through a connection signal with the electronic device. For example, the processor 25 may calculate an identifiable communication range based on the strength of the connection signal with the electronic device, the processor 25 will activate the object activation function only when the object is within the identifiable communication range.

In some embodiments, the object activation function corresponding to the target object TO comprises a screen display function. First, the processor 25 determines whether the target object TO has a communication connection with the smart glasses device 1. In some embodiments, the processor 25 actively resumes the previously established communication connection while the user C approaches the target object TO.

Then, in response to the target object TO having the communication connection with the smart glasses device 1, the processor 25 determines whether the user input points to the target object TO. Finally, in response to the user input pointing to the target object TO, the processor 25 generates a first control signal corresponding to the target object TO to transmit the first control signal to the target object TO, wherein the first control signal is configured to wake up the screen display function of the target object TO.

In addition, in response to the user input stopping pointing to the target object TO, the processor 25 generates a second control signal corresponding to the target object TO to transmit the second control signal to the target object TO, wherein the second control signal is configured to suspend the screen display function of the target object TO.

For example, the processor 25 can continuously monitor the user's eye gaze position and the connection signal with the electronic device. When the processor 25 determines that the user's eye gaze position moves from the target object TO to another position in the environment (i.e., the user input stops pointing to the target object TO), the processor 25 may generate a control signal to notify the target object TO to turn off the screen to save power. In addition, when the processor 25 determines that the connection signal with the electronic device is lower than a set value (i.e., the electronic device may have left the identifiable communication range or may be disconnected), the processor 25 will generate a control signal to notify the target object TO to turn off the screen.

In some embodiments, the object activation function corresponding to the target object TO comprises a remote control function. First, the processor 25 determines whether the target object TO has a communication connection with the smart glasses device 1. In some embodiments, the processor 25 actively resumes the previously established communication connection while the user C approaches the target object TO.

Then, in response to the target object TO having the communication connection with the smart glasses device 1, the processor 25 determines whether the target object TO executes a projection mode corresponding to a projection screen.

Then, in response to the target object TO executing the projection mode corresponding to the projection screen, the processor 25 generates a fifth control signal corresponding to the target object TO based on the user input of a coordinate located on the projection screen. Finally, the processor 25 transmits the fifth control signal to the target object TO to execute the remote control function corresponding to the target object TO.

It shall be appreciated that the processor 25 can determine whether the target object TO executes the projection mode through various methods. For example, the processor 25 can determine whether the target object TO executes the projection mode by directly receiving the return signal from the target object TO. For another example, the processor 25 can determine whether the target object TO executes the projection mode by comparing the projection screen with the display screen of the target object TO.

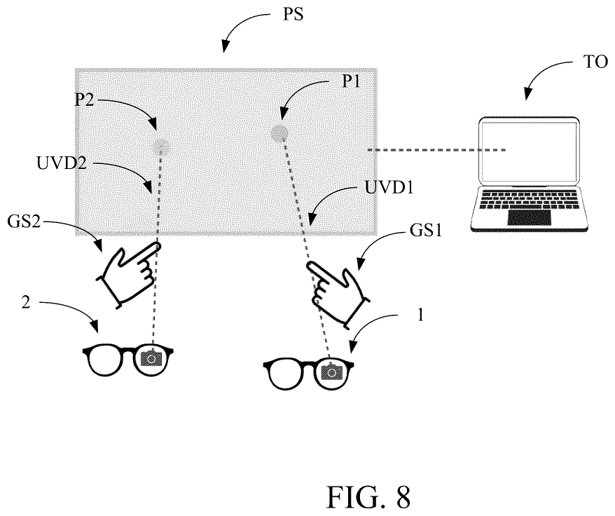

For ease of understanding, please refer to the remote control diagram in FIG. 8. In the present example, the processor 25 determines that the target object TO executes the projection mode corresponding to the projection screenPS. Next, the processor 25 of the smart glasses device 1 calculates the coordinate P1 on the projection screen PS based on the gesture GS1 and the user viewing direction UVD1. Then, the processor 25 can generate a control signal to the target object TO based on the coordinates P1 on the projection screen PS (for example, relative coordinates or real coordinates) and the gesture GS1 to execute the remote control function corresponding to the target object TO.

In the present example, another user can also wear the smart glasses device 2 and calculate the coordinate P2 on the projection screen PS based on the gesture GS2 and the user viewing direction UVD2 to execute the remote control function corresponding to the target object TO.

In some embodiments, the object activation function corresponding to the target object TO comprises a remote control function, and multiple objects can be provided in the environment to interact with each other, such as switching playback devices. Specifically, the processor 25 determines whether a second target object (i.e., an object different from the target object TO) appears in the real-time image, wherein the second target object is one of the objects.

Then, in response to the second target object appearing in the real-time image, the processor 25 determines whether each of the target object TO and the second target object has a communication connection with the smart glasses device 1. Then, in response to each of the target object TO and the second target object having the communication connection with the smart glasses device 1, the processor 25 determines whether the user input corresponds to a transfer gesture.

Subsequently, in response to the user input corresponding to the transfer gesture, the processor 25 generates a sixth control signal corresponding to the target object TO, wherein the sixth control signal is configured to instruct the target object TO to transmit a data content to the second target object for performing a playback operation. Finally, the processor 25 transmits the sixth control signal to the target object TO to execute the remote control function corresponding to the target object TO.

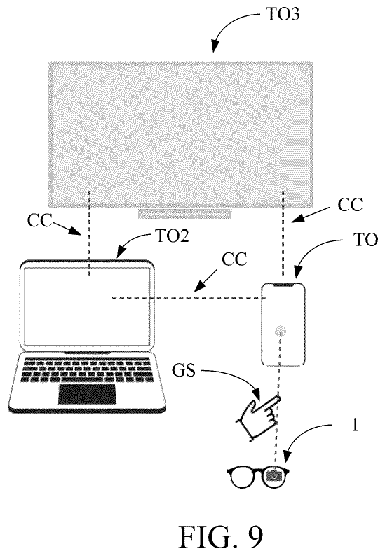

For ease of understanding, please refer to the remote control diagram in FIG. 9. In the present example, the processor 25 determines that there are the target object TO, the target object TO2, and the target object TO3 in the environment, and the target objects have communication connections CC with each other. In the present example, the user C selects data content from the target object TO through the gesture GS, and moves the gesture GS to the target object TO2.

In the present example, the processor 25 determines that the gesture GS corresponds to the transfer gesture. Then, the processor 25 generates a control signal to transfer the data content played by the target object TO to the target object TO2, and transmits the control signal to the target object TO, so that the target object TO performs the aforementioned transfer operation.

In addition, in the present example, the processor 25 can also select data content from the target object TO2 through the gesture GS, and move the gesture GS to the target object TO3, so that the target object TO2 performs the aforementioned transfer operation.

Next, the following paragraphs will describe specific implementations regarding non-electronic devices.

In some embodiments, the object activation function corresponding to the target object TO comprises a value recording function, such as automatically recording the water volume of a water bottle. First, in response to the target object TO appearing in the real-time image, the processor 25 determines whether the target object TO has a communication connection with the smart glasses device 1. Then, in response to the target object TO and the smart glasses device 1 not having the communication connection, the processor 25 generates a record value corresponding to the target object TO based on the real-time image to store the record value in the storage 21.

In some embodiments, in order to avoid misjudgment, the smart glasses device 1 can first determine the gesture of the user C or other user input (e.g., the eye gaze position) to determine whether to perform the corresponding function (for example, the gesture of the user C points to the target object TO). The object activation function corresponding to the target object TO comprises a value recording function. Specifically, in response to the target object TO appearing in the real-time image, the processor 25 determines whether the target object TO has a communication connection with the smart glasses device 1. Then, in response to the target object TO and the smart glasses device 1 not having the communication connection, the processor 25 determines whether a pointing gesture of the user C corresponds to the target object TO or whether the eye gaze position of the user C corresponds to the target object TO. Finally, in response to the pointing gesture of the user C corresponding to the target object TO or the eye gaze position of the user C corresponds to the target object TO, the processor 25 generates a record value corresponding to the target object TO based on the real-time image to store the record value in the storage 21.

For example, the user C stands on the weighing scale and points his finger to the weighing scale (i.e., the target object TO). The smart glasses device 1 will automatically record the value displayed on the weighing scale.

According to the above descriptions, the smart glasses device 1 provided by the present disclosure can actively identify the target object in the environment, and determine the object activation function to be executed for the target object based on the stored image identity list. In addition, the smart glasses device 1 provided by the disclosure also provides a variety of operating mechanisms to further provide a variety of remote control methods and different object activation functions, solving the shortcomings of the existing technology and improving user experience services.

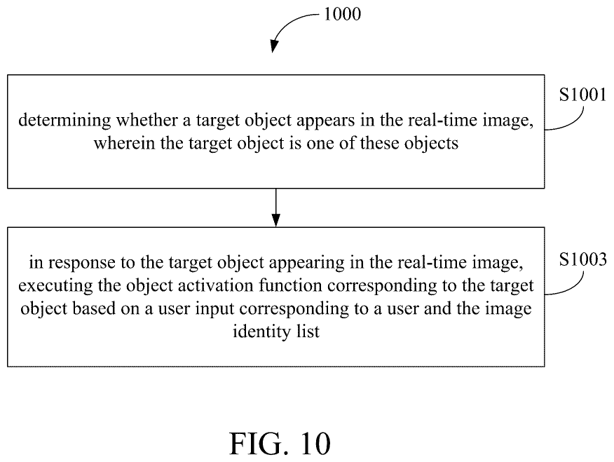

A second embodiment of the present disclosure is an object activation function executing method and a flowchart thereof is depicted in FIG. 10. The object activation function executing method 1000 is adapted for a smart glasses device (e.g., the smart glasses device 1 described in the first embodiment). The smart glasses device comprises a storage, an image capturing device, and a processor (e.g., the storage 21, the image capturing device 23, and the processor 25 described in the first embodiment). The storage is configured to store an image identity list. The image identity list comprises a plurality of objects and an object activation function corresponding to each of the objects. The image capturing device is configured to capture a real-time image. The object activation function executing method 1000 executes the object activation function corresponding to the target object through the steps S1001 to S1003.

In the step S1001, the smart glasses device determines whether a target object appears in the real-time image, wherein the target object is one of these objects.

Next, in the step S1003, in response to the target object appearing in the real-time image, the smart glasses device executes the object activation function corresponding to the target object based on a user input corresponding to a user and the image identity list.

In some embodiments, wherein the object activation function corresponding to the target object comprises a screen display function, and the step of executing the object activation function corresponding to the target object comprises the following steps: in response to the target object appearing in the real-time image, determining whether the user input points to the target object; in response to the user input pointing to the target object, generating a first control signal corresponding to the target object to transmit the first control signal to the target object, wherein the first control signal is configured to wake up the screen display function of the target object; and in response to the user input stopping pointing to the target object, generating a second control signal corresponding to the target object to transmit the second control signal to the target object, wherein the second control signal is configured to suspend the screen display function of the target object.

In some embodiments, wherein the smart glasses device further comprises an eye tracking device, the eye tracking device is configured to generate an eyeball trajectory of the user, the object activation function corresponding to the target object comprises a remote control function, and the step of executing the object activation function corresponding to the target object comprises the following steps: in response to the target object appearing in the real-time image, determining whether an eye gaze position of the user is on the target object based on the eyeball trajectory of the user; in response to the eye gaze position being on the target object, generating a third control signal corresponding to the target object based on the eye gaze position; and transmitting the third control signal to the target object to execute the remote control function corresponding to the target object.

In some embodiments, wherein the object activation function corresponding to the target object comprises a remote control function, and the step of executing the object activation function corresponding to the target object comprises the following steps: in response to the target object appearing in the real-time image, determining a gesture of the user based on the real-time image; calculating a user viewing direction corresponding to the gesture based on the real-time image and the gesture; determining whether the user viewing direction is on the target object; in response to the user viewing direction being on the target object, generating a fourth control signal corresponding to the target object based on a focus point generated by an intersection of the user viewing direction and the target object; and transmitting the fourth control signal to the target object to execute the remote control function corresponding to the target object.

In some embodiments, wherein the object activation function corresponding to the target object comprises a screen display function, and the step of executing the object activation function corresponding to the target object comprises the following steps: determining whether the target object has a communication connection with the smart glasses device; in response to the target object having the communication connection with the smart glasses device, determining whether the user input points to the target object; in response to the user input pointing to the target object, generating a first control signal corresponding to the target object to transmit the first control signal to the target object, wherein the first control signal is configured to wake up the screen display function of the target object; and in response to the user input stopping pointing to the target object, generating a second control signal corresponding to the target object to transmit the second control signal to the target object, wherein the second control signal is configured to suspend the screen display function of the target object.

In some embodiments, wherein the object activation function corresponding to the target object comprises a remote control function, and the step of executing the object activation function corresponding to the target object comprises the following steps: determining whether the target object has a communication connection with the smart glasses device; in response to the target object having the communication connection with the smart glasses device, determining whether the target object executes a projection mode corresponding to a projection screen; in response to the target object executing the projection mode corresponding to the projection screen, generating a fifth control signal corresponding to the target object based on the user input of a coordinate located on the projection screen; and transmitting the fifth control signal to the target object to execute the remote control function corresponding to the target object.

In some embodiments, wherein the object activation function corresponding to the target object comprises a remote control function, and the step of executing the object activation function corresponding to the target object comprises the following steps: determining whether a second target object appears in the real-time image, wherein the second target object is one of the objects; in response to the second target object appearing in the real-time image, determining whether each of the target object and the second target object has a communication connection with the smart glasses device; in response to each of the target object and the second target object having the communication connection with the smart glasses device, determining whether the user input corresponds to a transfer gesture; in response to the user input corresponding to the transfer gesture, generating a sixth control signal corresponding to the target object, wherein the sixth control signal is configured to instruct the target object to transmit a data content to the second target object for performing a playback operation; and transmitting the sixth control signal to the target object to execute the remote control function corresponding to the target object.

In some embodiments, wherein the object activation function executing method 1000 further comprises the following steps: in response to the target object leaving a field of view, suspending an execution of the object activation function corresponding to the target object.

In some embodiments, wherein the object activation function executing method 1000 further comprises the following steps: receiving a plurality of inertial sensing data from the target object; determining whether the target object is in a moving state based on the inertial sensing data; and in response to the target object being in the moving state, suspending an execution of the object activation function corresponding to the target object.

In some embodiments, wherein the object activation function corresponding to the target object comprises a value recording function, and the step of executing the object activation function corresponding to the target object comprises the following steps: in response to the target object appearing in the real-time image, determining whether the target object has a communication connection with the smart glasses device; and in response to the target object and the smart glasses device not having the communication connection, generating a record value corresponding to the target object based on the real-time image to store the record value in the storage.

In some embodiments, wherein the object activation function corresponding to the target object comprises a value recording function, and the step of executing the object activation function corresponding to the target object comprises the following steps: in response to the target object appearing in the real-time image, determining whether the target object has a communication connection with the smart glasses device; in response to the target object and the smart glasses device not having the communication connection, determining whether a pointing gesture of the user corresponds to the target object; and in response to the pointing gesture of the user corresponding to the target object, generating a record value corresponding to the target object based on the real-time image to store the record value in the storage.

In addition to the aforesaid steps, the second embodiment can also execute all the operations and steps of the smart glasses device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The object activation function executing method described in the second embodiment may be implemented by a computer program having a plurality of codes. The computer program may be a file that can be transmitted over the network, or may be stored into a non-transitory computer readable storage medium. After the codes of the computer program are loaded into an electronic device (e.g., the smart glasses device 1), the computer program executes the object activation function executing method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the control signal, the target object, etc.) are preceded by terms such as “first”, “second”, “third”, “fourth”, “fifth”, or “sixth”, and these terms of “first”, “second”, “third”, “fourth”, “fifth”, or “sixth” are only used to distinguish these different words. For example, the “first” and “second” control signals are only used to indicate the control signal used in different operations.

According to the above descriptions, the object activation function executing technology (at least including the device, the method, and the non-transitory computer readable storage medium) provided by the present disclosure can actively identify the target object in the environment, and determine the object activation function to be executed for the target object based on the stored image identity list. In addition, the object activation function executing technology provided by the disclosure also provides a variety of operating mechanisms to further provide a variety of remote control methods and different object activation functions, solving the shortcomings of the existing technology and improving user experience services.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A smart glasses device, comprising:
a storage, being configured to store an image identity list, wherein the image identity list comprises a plurality of objects and an object activation function corresponding to each of the objects;
an image capturing device, being configured to capture a real-time image; and
a processor, being electrically connected to the storage and the image capturing device, and being configured to perform the following operations:
determining whether a target object appears in the real-time image, wherein the target object is one of these objects; and
in response to the target object appearing in the real-time image, executing the object activation function corresponding to the target object based on a user input corresponding to a user and the image identity list.

2. The smart glasses device of claim 1, wherein the object activation function corresponding to the target object comprises a screen display function, and the operation of executing the object activation function corresponding to the target object comprises the following operations:
in response to the target object appearing in the real-time image, determining whether the user input points to the target object;
in response to the user input pointing to the target object, generating a first control signal corresponding to the target object to transmit the first control signal to the target object, wherein the first control signal is configured to wake up the screen display function of the target object; and
in response to the user input stopping pointing to the target object, generating a second control signal corresponding to the target object to transmit the second control signal to the target object, wherein the second control signal is configured to suspend the screen display function of the target object.

3. The smart glasses device of claim 1, wherein the smart glasses device further comprises:
an eye tracking device, being configured to generate an eyeball trajectory of the user;
wherein the object activation function corresponding to the target object comprises a remote control function, and the operation of executing the object activation function corresponding to the target object comprises the following operations:
in response to the target object appearing in the real-time image, determining whether an eye gaze position of the user is on the target object based on the eyeball trajectory of the user;
in response to the eye gaze position being on the target object, generating a third control signal corresponding to the target object based on the eye gaze position; and
transmitting the third control signal to the target object to execute the remote control function corresponding to the target object.

4. The smart glasses device of claim 1, wherein the object activation function corresponding to the target object comprises a remote control function, and the operation of executing the object activation function corresponding to the target object comprises the following operations:
in response to the target object appearing in the real-time image, determining a gesture of the user based on the real-time image;
calculating a user viewing direction corresponding to the gesture based on the real-time image and the gesture;
determining whether the user viewing direction is on the target object; and
in response to the user viewing direction being on the target object, generating a fourth control signal corresponding to the target object based on a focus point generated by an intersection of the user viewing direction and the target object; and
transmitting the fourth control signal to the target object to execute the remote control function corresponding to the target object.

5. The smart glasses device of claim 1, wherein the object activation function corresponding to the target object comprises a screen display function, and the operation of executing the object activation function corresponding to the target object comprises the following operations:
determining whether the target object has a communication connection with the smart glasses device;
in response to the target object having the communication connection with the smart glasses device, determining whether the user input points to the target object;
in response to the user input pointing to the target object, generating a first control signal corresponding to the target object to transmit the first control signal to the target object, wherein the first control signal is configured to wake up the screen display function of the target object; and
in response to the user input stopping pointing to the target object, generating a second control signal corresponding to the target object to transmit the second control signal to the target object, wherein the second control signal is configured to suspend the screen display function of the target object.

6. The smart glasses device of claim 1, wherein the object activation function corresponding to the target object comprises a remote control function, and the operation of executing the object activation function corresponding to the target object comprises the following operations:
determining whether the target object has a communication connection with the smart glasses device;
in response to the target object having the communication connection with the smart glasses device, determining whether the target object executes a projection mode corresponding to a projection screen;
in response to the target object executing the projection mode corresponding to the projection screen, generating a fifth control signal corresponding to the target object based on the user input of a coordinate located on the projection screen; and
transmitting the fifth control signal to the target object to execute the remote control function corresponding to the target object.

7. The smart glasses device of claim 1, wherein the object activation function corresponding to the target object comprises a remote control function, and the operation of executing the object activation function corresponding to the target object comprises the following operations:
determining whether a second target object appears in the real-time image, wherein the second target object is one of the objects;
in response to the second target object appearing in the real-time image, determining whether each of the target object and the second target object has a communication connection with the smart glasses device;
in response to each of the target object and the second target object having the communication connection with the smart glasses device, determining whether the user input corresponds to a transfer gesture;
in response to the user input corresponding to the transfer gesture, generating a sixth control signal corresponding to the target object, wherein the sixth control signal is configured to instruct the target object to transmit a data content to the second target object for performing a playback operation; and
transmitting the sixth control signal to the target object to execute the remote control function corresponding to the target object.

8. The smart glasses device of claim 1, wherein the processor further performs the following operations:
in response to the target object disappearing in the real-time image, suspending an execution of the object activation function corresponding to the target object.

9. The smart glasses device of claim 1, wherein the processor further performs the following operations:
receiving a plurality of inertial sensing data from the target object;
determining whether the target object is in a moving state based on the inertial sensing data, ; and
in response to the target object being in the moving state, suspending an execution of the object activation function corresponding to the target object.

10. The smart glasses device of claim 1, wherein the object activation function corresponding to the target object comprises a value recording function, and the operation of executing the object activation function corresponding to the target object comprises the following operations:
in response to the target object appearing in the real-time image, determining whether the target object has a communication connection with the smart glasses device; and
in response to the target object and the smart glasses device not having the communication connection, generating a record value corresponding to the target object based on the real-time image to store the record value in the storage.

11. The smart glasses device of claim 1, wherein the object activation function corresponding to the target object comprises a value recording function, and the operation of executing the object activation function corresponding to the target object comprises the following operations:
in response to the target object appearing in the real-time image, determining whether the target object has a communication connection with the smart glasses device;
in response to the target object and the smart glasses device not having the communication connection, determining whether a pointing gesture of the user corresponds to the target object; and
in response to the pointing gesture of the user corresponding to the target object, generating a record value corresponding to the target object based on the real-time image to store the record value in the storage.

12. An object activation function executing method, being adapted for use in a smart glasses device, wherein the smart glasses device comprises a storage, an image capturing device, and a processor, the storage is configured to store an image identity list, the image identity list comprises a plurality of objects and an object activation function corresponding to each of the objects, the image capturing device is configured to capture a real-time image, and the object activation function executing method comprises:
determining whether a target object appears in the real-time image, wherein the target object is one of these objects; and
in response to the target object appearing in the real-time image, executing the object activation function corresponding to the target object based on a user input corresponding to a user and the image identity list.

13. The object activation function executing method of claim 12, wherein the object activation function corresponding to the target object comprises a screen display function, and the step of executing the object activation function corresponding to the target object comprises the following steps:
in response to the target object appearing in the real-time image, determining whether the user input points to the target object;
in response to the user input pointing to the target object, generating a first control signal corresponding to the target object to transmit the first control signal to the target object, wherein the first control signal is configured to wake up the screen display function of the target object; and
in response to the user input stopping pointing to the target object, generating a second control signal corresponding to the target object to transmit the second control signal to the target object, wherein the second control signal is configured to suspend the screen display function of the target object.

14. The object activation function executing method of claim 12, wherein the smart glasses device further comprises an eye tracking device, the eye tracking device is configured to generate an eyeball trajectory of the user, the object activation function corresponding to the target object comprises a remote control function, and the step of executing the object activation function corresponding to the target object comprises the following steps:
in response to the target object appearing in the real-time image, determining whether an eye gaze position of the user is on the target object based on the eyeball trajectory of the user;
in response to the eye gaze position being on the target object, generating a third control signal corresponding to the target object based on the eye gaze position; and
transmitting the third control signal to the target object to execute the remote control function corresponding to the target object.

15. The object activation function executing method of claim 12, wherein the object activation function corresponding to the target object comprises a remote control function, and the step of executing the object activation function corresponding to the target object comprises the following steps:
in response to the target object appearing in the real-time image, determining a gesture of the user based on the real-time image;
calculating a user viewing direction corresponding to the gesture based on the real-time image and the gesture;
determining whether the user viewing direction is on the target object;
in response to the user viewing direction being on the target object, generating a fourth control signal corresponding to the target object based on a focus point generated by an intersection of the user viewing direction and the target object; and
transmitting the fourth control signal to the target object to execute the remote control function corresponding to the target object.

16. The object activation function executing method of claim 12, wherein the object activation function corresponding to the target object comprises a screen display function, and the step of executing the object activation function corresponding to the target object comprises the following steps:
determining whether the target object has a communication connection with the smart glasses device;
in response to the target object having the communication connection with the smart glasses device, determining whether the user input points to the target object;
in response to the user input pointing to the target object, generating a first control signal corresponding to the target object to transmit the first control signal to the target object, wherein the first control signal is configured to wake up the screen display function of the target object; and
in response to the user input stopping pointing to the target object, generating a second control signal corresponding to the target object to transmit the second control signal to the target object, wherein the second control signal is configured to suspend the screen display function of the target object.

17. The object activation function executing method of claim 12, wherein the object activation function corresponding to the target object comprises a remote control function, and the step of executing the object activation function corresponding to the target object comprises the following steps:
determining whether the target object has a communication connection with the smart glasses device;
in response to the target object having the communication connection with the smart glasses device, determining whether the target object executes a projection mode corresponding to a projection screen;
in response to the target object executing the projection mode corresponding to the projection screen, generating a fifth control signal corresponding to the target object based on the user input of a coordinate located on the projection screen; and
transmitting the fifth control signal to the target object to execute the remote control function corresponding to the target object.

18. The object activation function executing method of claim 12, wherein the object activation function corresponding to the target object comprises a remote control function, and the step of executing the object activation function corresponding to the target object comprises the following steps:
determining whether a second target object appears in the real-time image, wherein the second target object is one of the objects;
in response to the second target object appearing in the real-time image, determining whether each of the target object and the second target object has a communication connection with the smart glasses device;
in response to each of the target object and the second target object having the communication connection with the smart glasses device, determining whether the user input corresponds to a transfer gesture;
in response to the user input corresponding to the transfer gesture, generating a sixth control signal corresponding to the target object, wherein the sixth control signal is configured to instruct the target object to transmit a data content to the second target object for performing a playback operation; and
transmitting the sixth control signal to the target object to execute the remote control function corresponding to the target object.

19. The object activation function executing method of claim 12, wherein the object activation function executing method further comprises the following steps:
in response to the target object disappearing in the real-time image, suspending an execution of the object activation function corresponding to the target object.

20. A non-transitory computer readable storage medium, having a computer program stored therein, wherein the computer program comprises a plurality of codes, the computer program executes an object activation function executing method after being loaded into an electronic system, the electronic system comprises a storage, an image capturing device, and a processor, the storage is configured to store an image identity list, the image identity list comprises a plurality of objects and an object activation function corresponding to each of the objects, the image capturing device is configured to capture a real-time image, and the object activation function executing method comprises:
determining whether a target object appears in the real-time image, wherein the target object is one of these objects; and
in response to the target object appearing in the real-time image, executing the object activation function corresponding to the target object based on a user input corresponding to a user and the image identity list.
